(19) United States
(12) Patent Application Publication
(10) Pub. No.: US 2004/0238003 A1
(43) Pub. Date: Dec. 2, 2004

(54) Stencil cleaner for use in the solder paste print operation

(76) Inventors: Gerald Pham-Van-Diep, Hopkinton, MA (US); Mark Rossmeisl, Franklin, MA (US); Gary T. Freeman, Prides Crossing, MA (US)

Correspondence Address: LOWRIE, LANDO & ANASTASI, RIVERFRONT OFFICE, ONE MAIN STREET, ELEVENTH FLOOR, CAMBRIDGE, MA, 02142, US

(21) Appl. No.: 10/448,761

(22) Filed: May 30, 2003

(51) Int. Cl. B05D 5/12; B05C 5/00; B08B 7/00

(52) U.S. Cl. 134/7; 427/421.1; 427/58; 118/301

(57) ABSTRACT

An apparatus for performing operations on a surface of an electronic substrate, the apparatus comprising a frame, a dispenser coupled to the frame to dispense material onto the electronic substrate, a stencil coupled to the frame having at least one aperture to receive the material to be deposited through the aperture onto the surface of the electronic substrate, a controller that controls dispensing of materials on substrates, and a cleaning system coupled to the frame and coupled to the controller for removing material from the stencil, wherein the cleaning system uses carbon dioxide particles for removing the residue from the stencil.

### FIELD OF THE INVENTION

The invention relates to apparatus and methods for screen printing, and more specifically to apparatus and methods for the screen printing of electronic substrates such as circuit board assemblies.

### BACKGROUND OF THE INVENTION

The manufacturing of circuit boards involves many processes, one of which is the screen printing of solder paste or other adhesives on the surface of a circuit board so that electronic components can thereafter be deposited onto the board. The boards typically have a pattern of pads or some other conductive surface onto which solder paste will be deposited. To accomplish the deposition of solder paste, a stencil is created that has an aperture or a plurality of apertures defining a pattern to be printed on the surface of the board. The solder paste or other adhesive to be deposited on the board is placed on top of the stencil for deposition into the aperture or apertures. A squeegee or wiper blade is passed over the stencil and forces the solder paste into the apertures. Excess solder paste may then be removed from the top of the stencil so that substantially all of the solder paste that remains is in the aperture or apertures. The stencil is then separated from the board and the adhesion between the board and the solder paste causes most of the material to stay on the board.

Because the pads used on circuit boards are becoming smaller and smaller, the size of the apertures on stencils is also becoming smaller. For smaller apertures, the adhesion between the solder paste and the board does not always allow all of the material in the aperture to transfer from the stencil to the board, resulting in residue being left on the stencil that contaminates the stencil. In addition, after deposition of solder paste on several boards, solder paste can accumulate on the bottom of the stencil. Thus, it is often desirable to adequately clean the surface of the stencil to remove the excess material so that the stencil can be used effectively in multiple print cycles.

### SUMMARY OF THE INVENTION

In general, in one aspect, the invention provides an apparatus for performing operations on a surface of an electronic substrate. The apparatus includes a frame, a dispenser coupled to the frame to dispense a material onto the electronic substrate, a stencil coupled to the frame having at least one aperture to receive the material to be deposited through the aperture onto the surface of the electronic substrate, a controller that controls dispensing of materials on substrates, and a cleaning system coupled to the frame and coupled to the controller and constructed and arranged to remove material from the stencil by dispensing a gas toward the stencil.

Implementations of the invention may include one or more of the following features. The gas can be particulate carbon dioxide. The cleaning system can be moveable along a surface of the stencil. The cleaning system can have a nozzle to dispense carbon dioxide particles. The nozzle may be a bar having a plurality of injectors along the length of the bar. The bar having a plurality of injectors along its length can be the same length as the width of the stencil.

Further implementations of the invention may include one or more of the following features. The cleaning system can include a vacuum system to remove a residue of the material from the stencil. The vacuum system can further include a chamber, and the chamber can be constructed and arranged to be an enclosed area in contact with the stencil to collect the residue from the stencil.

In general, in another aspect, the invention provides a method of dispensing material on a surface of an electronic substrate. The method includes loading an electronic substrate into a printing apparatus, aligning a stencil above a surface of the electronic substrate, the stencil having at least one aperture through which material is deposited onto the surface of the electronic substrate, depositing the material onto the surface of the electronic substrate via the apertures in the stencil, separating the stencil and the substrate, and cleaning a surface of the stencil using carbon dioxide particles. The electronic substrate can be a circuit board. The carbon dioxide particles can be sprayed onto a surface of the electronic substrate with a nozzle.

Generally, in another aspect, the invention provides an apparatus for dispensing material onto a surface of an electronic substrate. The apparatus includes a frame, a dispenser coupled to the frame to deposit a material onto a surface of the electronic substrate, a stencil coupled to the frame having at least one aperture to receive the material to be deposited through the aperture onto the surface of the electronic substrate, a controller that controls dispensing of materials on substrates and moving substrates downstream in the printing process, and means for applying carbon dioxide particles onto a surface of the stencil to remove material from the stencil.

Implementations of the invention may include one or more of the following features. The means for applying carbon dioxide particles may be a nozzle. The nozzle can be a bar having a plurality of injectors along its length.

The invention will be more fully understood after a review of the following figures, detailed descriptions and claims.

### BRIEF DESCRIPTION OF THE DRAWINGS

For a better understanding of the present invention, reference is made to the drawings which are incorporated herein by reference and in which:

FIG. 1 is a perspective view of a printing apparatus in accordance with one embodiment of the invention;

FIG. 2 is a top view of a printing apparatus showing a stencil cleaning apparatus in accordance with one embodiment of the invention;

FIG. 3 is a cross-sectional diagram of the stencil cleaning apparatus of FIG. 2 in accordance with one embodiment of the invention; and

FIG. 4 is a flow chart depicting a stencil cleaning method in accordance with one embodiment of the invention.

### DETAILED DESCRIPTION OF PREFERRED EMBODIMENTS

Embodiments of the present invention are described below with reference to screen printers or stencil printers that print solder paste onto circuit boards. As understood by those skilled in the art, embodiments of the present invention can be used with electronic substrates other than circuit boards and with machines other than screen printers, such as other machines used in the deposition of viscous materials. For example, embodiments of the present invention can be used with machines that print adhesives on electronic subassemblies, such as circuit boards. Embodiments of the present invention include systems and methods that use carbon dioxide particles for removing material from a stencil. As understood by those skilled in the art, embodiments of the present invention can be used with gases, other than carbon dioxide, that exhibit suitable properties.

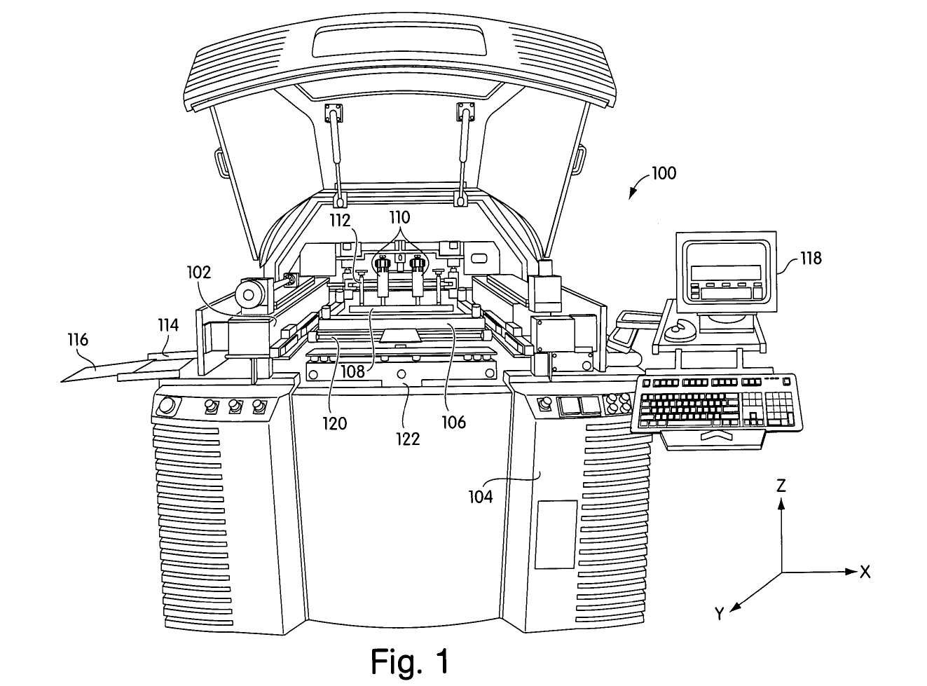

Referring to FIG. 1, a printer 100 in accordance with one embodiment of the invention that applies solder paste or other materials to substrates, such as circuit boards, is shown. The printer is an improvement over the screen printers described in U.S. Pat. No. 5,794,329 and U.S. Pat. No. 6,324,973, each of which is hereby incorporated by reference.

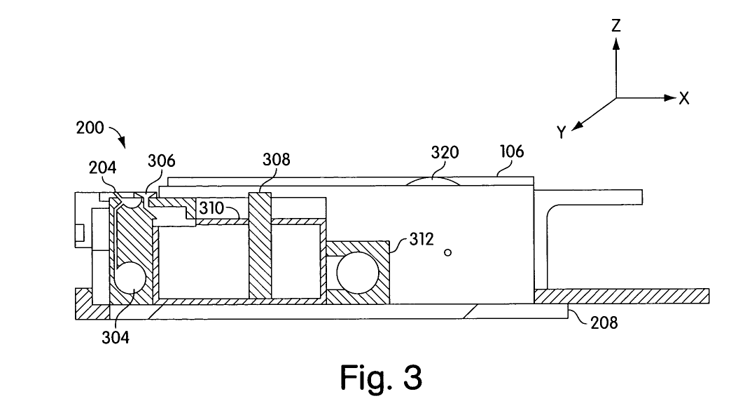

As shown in FIG. 1, the printer 100 includes a frame 102, a controller 104, a monitor 118, a stencil 106, solder paste cartridges 110, a dispensing head/squeegee 108, a board support mechanism 122, a tractor feed mechanism 114 and a circuit board 116. The circuit board enters the printer 100 on the tractor feed mechanism 114. The stencil 106 is attached fixedly to the frame 102 in a position above the position in which the circuit board 116 will enter the printer on the tractor feed mechanism 114. The dispenser head/squeegee 108 is in proximity to the solder paste cartridges 110 and is attached to the printer 100 in a position above the solder stencil 106. The solder stencil 106 has apertures 320 (shown in FIG. 3) through which solder is deposited on the surface of a circuit board.

Circuit boards 116 fed into the printer 100 typically have a pattern of pads or other, usually conductive surface areas onto which solder paste will be deposited. When directed by the controller 104 of the printer, the tractor feed mechanism 114 supplies boards to a location over the board support mechanism and under the stencil 106. Once arriving at the position under the stencil 106, the circuit board 116 is in place for a manufacturing operation. To successfully deposit solder paste on the circuit board 116, the circuit board 116 and the stencil 106 are aligned, via the controller. When the solder stencil 106 and the circuit board 116 are aligned correctly, the stencil is lowered toward the board 116 for application of the solder paste through the apertures, or the circuit board can be raised toward the stencil by the support mechanism 122.

The pattern of the apertures on the stencil corresponds to the pattern of conductive surfaces or pads already on the circuit board 116. The dispenser head/squeegee 108, positioned above the stencil 106, can vary the amount of solder paste delivered on the stencil 106 and applied by the squeegee. The squeegee 108 wipes across the stencil, thereby pushing solder paste into the stencil apertures and onto the board 116. Solder paste remains on the circuit board 116 in the proper pattern when the support mechanism supporting the board moves downward away from the position of the stencil, or the stencil moves upward away from the board, under control of the controller. The surface tension between the circuit board 116 and the solder paste causes most of the solder paste to remain on the circuit board when the circuit board 116 and the stencil 106 are separated. The controller then controls movement of the circuit board 116 to the next location using the tractor feed mechanism, where electrical components will be placed on the circuit board 116.

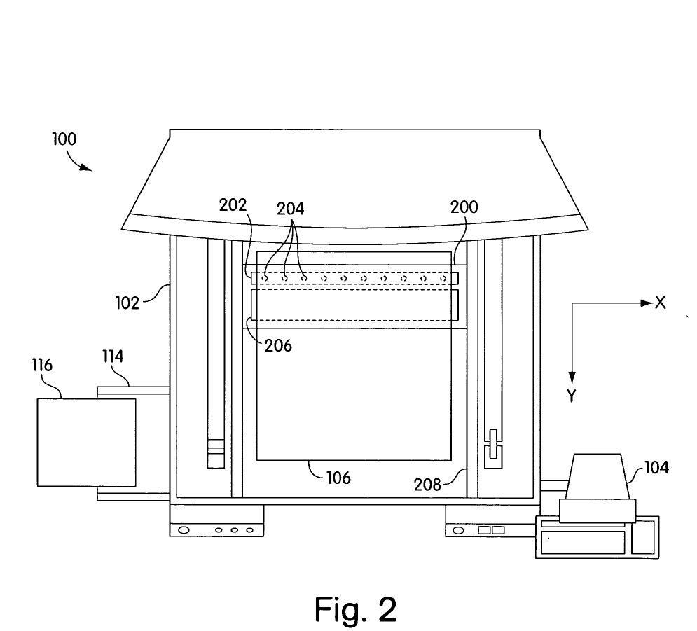

In embodiments of the present invention, a carbon dioxide (CO₂) cleaning system is employed to remove solder paste from apertures of the stencil and from the bottom surface of the stencil after a print cycle on a particular circuit board is complete and in preparation for printing a next circuit board being fed into the printer. Depending on the size of the aperture and the type of material being deposited, cleaning may be done after every print cycle or after several print cycles. Referring to FIG. 2, which shows a top view of the printer 100 discussed with reference to FIG. 1, in one embodiment of the present invention, a cleaning system 200 is embedded in the printer below the level of the stencil 106 and attached to a gantry moveable along tracks 208. In the view shown in FIG. 2, several components of the printer are not shown, so that the cleaning system can be shown more clearly. The cleaning system 200 has nozzles 204 positioned along a bar 202. The cleaning system also has a vacuum chamber 206. As a unit, the cleaning system 200 embodying the nozzles and the vacuum moves on the tracks 208 in the linear Y-axis of motion underneath the stencil, and from one end of the stencil 106 to the other.

FIG. 3 illustrates the cleaning system 200 in more detail. Referring to FIG. 2 and FIG. 3, the cleaning system 200 includes the bar 202 with injectors 204, a supply cavity 304, a vacuum nozzle 306 and a vacuum chamber 310, a removable filter element 308 and an integral vacuum generator 312. In one embodiment the bar 202 having injectors 204 is substantially the same length in the X-axis direction as the width of the stencil 106. The nozzles 204 are connected to the supply cavity 304. The supply cavity 304 is a compressorized container holding carbon dioxide in a gaseous state. As the carbon dioxide passes through the injectors 204, the pressure causes a phase change of the carbon dioxide from gas into particulate carbon dioxide, commonly known as dry ice. The injectors 204 are pointed upward to spray CO₂ particles at the undersurface of the stencil 106 at a substantially high velocity. The injectors 204 are of a diameter such that no clogging of the injectors will occur due to the passage of carbon dioxide particles as the particles are sprayed at the stencil. The vacuum nozzle 306 is positioned to be in close proximity to the bar 202 having injectors 204.

The system 200 operates as follows. At the direction of the controller, the cleaning system 200 moves on tracks 208 in the Y-axis of motion below the underside of the stencil 106 having apertures 320. As the cleaning system moves along the tracks 208, the injectors 204 are pointed directly at the surface of the stencil and spray carbon dioxide particles onto the surface of the stencil at a high velocity. Multiple injectors 204 positioned along the length of the bar 202 allow CO₂ particles to be sprayed across substantially the entire undersurface of the stencil 106 and into the apertures of the stencil. The CO₂ particles work to loosen the solder paste residue caught in the apertures and on the undersurface of the board by directly impacting the stencil contaminants.

As carbon dioxide particles sublimate into the air, the dislodged solder residue is drawn away from the surface of the stencil by the vacuum nozzle 306. The vacuum nozzle is connected to the vacuum chamber 310, which has a large volume and a low airspeed that allows the byproduct to collect readily. Once the vacuum 206 collects the residual byproduct, the residue can be disposed of properly with substantially no other waste produced, as the carbon dioxide particles evaporate so that no contamination is left on the stencil. The filter 308 is removable for replacement purposes. The chamber 310 is removable from the overall vacuum system for both disposal of residue that may have accumulated in it, and for easy cleaning.

The chamber 310 can be constructed to contact the surface of the stencil and form a seal, such that residue is contained in an enclosed area when removed from the stencil. The sealed or enclosed area collects all, or substantially all, of the residue removed from the stencil, including residue that is not drawn in by the vacuum nozzle. The contacting member of the chamber 310 can moveably connect to the stencil so that it encompasses the area directly surrounding the injectors 204 and moves with the injectors 204, or it can contact the stencil 106 around the perimeter of the stencil so that substantially the whole bottom surface of the stencil 106 faces the interior of the sealed area for the duration of removal of residue. Residue is prevented from entering other areas of the printer or the ambient air by being contained in the sealed enclosure of the vacuum. In addition to removing reside from the surface of the stencil, the chamber can collect the residual carbon dioxide and prevent it from entering the ambient air.

At the completion of use of the cleaning system, the stencil is left substantially free from residual adhesives on its surface and is thus prepared for another printing cycle. The cleaning system 200 returns to a resting position until called upon by the controller 104 to repeat the stencil cleaning process.

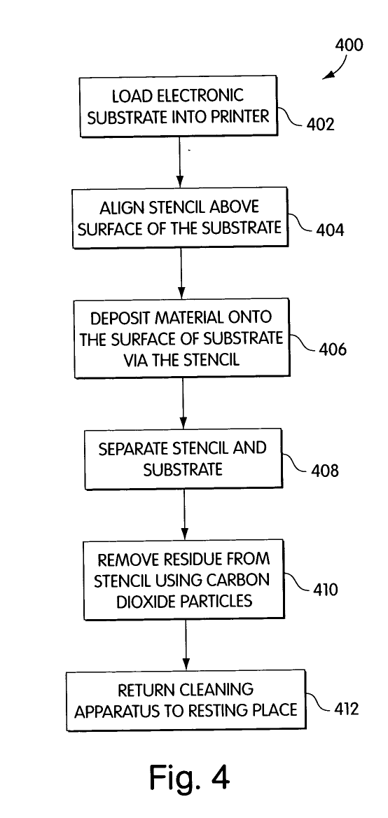

A flow chart depicting a method 400 by which the cleaning system operates is found in FIG. 4. A circuit board is loaded into the printer in stage 402, where it is transported to a position below the stencil 106. The controller 104 aligns the stencil above the surface of the circuit board as shown in 404. Material is then deposited onto the surface of the circuit board, stage 406, through apertures in the stencil 106. When this process is completed, the stencil and the circuit board are separated 408 so that the circuit board can be transported to the next phase in the production process. Excess material can then be removed from the stencil, stage 410, using the carbon dioxide particle cleaning system. At the completion of cleaning and removal of residue material, the cleaning apparatus is directed by the controller to return to its resting position in stage 412 where it remains until it is called upon to repeat the stencil cleaning process.

In the embodiments of the present invention described above, the cleaning system including the vacuum and the bar having injectors, moves as a complete unit along the undersurface of a stencil to accomplish cleaning of the stencil. As understood by those skilled in the art, other configurations may include a cleaning system wherein the injector nozzle bar moves across the undersurface of the stencil with the vacuum nozzle attached, while the vacuum chamber with the filter remains in a fixed position.

In the embodiments of the present invention described above, the bar having injectors includes multiple nozzles along a single bar. As understood by those skilled in the art, other configurations may include a single injector nozzle that moves across the undersurface of the stencil to inject CO₂ particles.

In the embodiments of the present invention described above, the bar having injectors includes multiple nozzles along a single bar. As understood by those skilled in the art, other configurations may include multiple bars having injectors in parallel and in a fixed position below the level of a stencil for injection of CO₂ particles onto the stencil to accomplish cleaning of the stencil.

In the embodiments of the present invention described above, the carbon dioxide is contained in a supply cavity that is local to a circuit board printing apparatus. As understood by those skilled in the art, other configurations may include a carbon dioxide supply container that provides carbon dioxide to a plurality of cleaning systems mounted in printing machines. In such embodiments, the carbon dioxide container can be connected to the plurality of cleaning systems by flexible hose.

In the embodiments of the present invention, the cleaning system is attached in a position below the surface of the stencil. As understood by those skilled in the art, other configurations may include a cleaning system attached to the frame above the stencil position in addition to or in replacement of the cleaning system in position below the stencil such that CO₂ particles are sprayed on the top surface of the stencil for cleaning. The cleaning system can contact the top surface of the stencil and the bottom surface of the stencil to form chambers such that residue does not escape into the surrounding areas. In still other embodiments, the cleaning system may be mounted to the side of the stencil, with the stencil being moveable towards the cleaning system when cleaning is desired.

Having thus described at least one illustrative embodiment of the invention, various alterations, modifications and improvements will readily occur to those skilled in the art. Such alterations, modifications and improvements are intended to be within the scope and spirit of the invention. Accordingly, the foregoing description is by way of example only and is not intended as limiting. The invention's limit is defined only in the following claims and the equivalents thereto.

What is claimed is:

1. An apparatus for performing operations on a surface of an electronic substrate, the apparatus comprising:
a frame;
a dispenser, coupled to the frame, to dispense a material onto the electronic substrate;
a stencil coupled to the frame having at least one aperture to receive the material to be deposited through the aperture onto the surface of the electronic substrate;
a controller that controls dispensing of materials on substrates; and
a cleaning system coupled to the frame and coupled to the controller and constructed and arranged to remove material from the stencil by dispensing a gas towards the stencil.

2. The apparatus of claim 1 wherein the gas is particulate carbon dioxide.

3. The apparatus of claim 1 wherein the gas changes to a particulate solid phase when pressurized.

4. The apparatus of claim 3 wherein the electronic substrate is a circuit board.

5. The apparatus of claim 4 wherein the cleaning system is constructed and arranged to be moveable along a surface of the stencil.

6. The apparatus of claim 5 wherein the cleaning system further comprises at least one nozzle to dispense carbon dioxide particles.

7. The apparatus of claim 5 wherein the cleaning system further includes a bar having a length with a plurality of injectors along the length of the bar.

8. The apparatus of claim 7 wherein the stencil has a width and the length of the bar is substantially equal to the width of the stencil.

9. The apparatus of claim 8 wherein the cleaning system includes a vacuum system to collect a residue of the material removed from the stencil.

10. The apparatus of claim 9 wherein the vacuum system further comprises a chamber, and wherein the chamber is constructed and arranged to contact the stencil.

11. A method of dispensing material on a surface of an electronic substrate, the method comprising:
loading an electronic substrate into a printing apparatus;
aligning a stencil above a surface of the electronic substrate, the stencil having at least one aperture through which material is deposited onto the surface of the electronic substrate;
depositing the material onto the surface of the electronic substrate via the aperture in the stencil;
separating the stencil and the substrate; and
cleaning a surface of the stencil using carbon dioxide particles.

12. The method of claim 11 wherein the electronic substrate is a circuit board.

13. The method of claim 12 further comprising spraying carbon dioxide particles onto the surface of the stencil.

14. The method of claim 13 further comprising moving a cleaning system having a nozzle along a surface of the stencil to spray carbon dioxide particles.

15. The method of claim 14 further comprising drawing the material removed from the stencil into a chamber for collection of the material.

16. The method of claim 15 further comprising contacting the surface of the stencil with a portion of a sealed chamber and collecting residue in the sealed chamber.

17. An apparatus for dispensing material on at least one surface of an electronic substrate, the apparatus comprising:
a frame;
a dispenser, coupled to the frame, to deposit a material onto a surface of the electronic substrate;
a stencil coupled to the frame having at least one aperture to receive the material to be deposited through the aperture onto the surface of the electronic substrate;
a controller that controls dispensing of materials on substrates; and
means for applying carbon dioxide particles onto a surface of the stencil to remove material from the stencil.

18. The apparatus of claim 17 wherein the electronic substrate is a circuit board.

19. The apparatus of claim 18 wherein the means for applying carbon dioxide particles includes a nozzle.

20. The apparatus of claim 19 wherein the nozzle includes a bar having a plurality of injectors along its length.

21. The apparatus of claim 20 wherein the bar having a plurality of injectors is moveable along a surface of the stencil.

22. The apparatus of claim 17 further comprising means for collecting material removed from the stencil.

23. An apparatus for cleaning a surface of a stencil used to print circuit boards, the apparatus comprising:
a gantry moveable along the surface of the stencil;
a nozzle, coupled to the gantry, having an injector for dispensing a cleaning substance onto the surface of the stencil;
a vacuum nozzle;
a vacuum chamber, coupled to the vacuum nozzle; and
wherein the vacuum nozzle is positioned to remove residue from the surface of the stencil after a cleaning substance has been dispensed thereon and deposit residue in the vacuum chamber.

24. The apparatus of claim 23, wherein the cleaning substance includes carbon dioxide particles.

25. The apparatus of claim 24 wherein the vacuum nozzle and the vacuum chamber are coupled to the gantry to move along the surface of the stencil in proximity of the nozzle.

26. The apparatus of claim 25 wherein the chamber contacts the surface of the stencil to form a sealed area for collection of residue that is removed from the stencil.
